(19) United States
(12) Patent Application Publication
(10) Pub. No.: US 2025/0344768 A1
(43) Pub. Date: Nov. 13, 2025

(54) INDUCTION HEATING SYSTEM WITH TEMPERATURE FEEDBACK FOR USE WITH ELECTRONIC VAPORIZER AND ELECTRONIC VAPORIZER THAT UTILIZES AN INDUCTION HEATING SYSTEM COUPLED WITH TEMPERATURE FEEDBACK

(71) Applicant: DRD LLC, Las Vegas, NV (US)

(72) Inventors: Christopher Ortega, Las Vegas, NV (US); Jamie M. Rosen, Las Vegas, NV (US); Ka Ho Lai, Las Vegas, NV (US)

(73) Assignee: DRD LLC, Las Vegas, NV (US)

(21) Appl. No.: 19/092,123

(22) Filed: Mar. 27, 2025

Related U.S. Application Data
(60) Provisional application No. 63/644,261, filed on May 8, 2024.

(51) Int. Cl. A24F 40/57; A24F 40/465; A24F 40/485; A24F 40/60; G01J 5/12; H05B 6/06; H05B 6/10

(52) U.S. Cl. CPC A24F 40/57; A24F 40/465; A24F 40/485; A24F 40/60; G01J 5/12; H05B 6/06; H05B 6/105

(57) ABSTRACT

An electronic vaporizer has a main unit, a heating system and a controller. The main unit is configured to supply electrical energy. The heating system is coupled to the main unit and includes an induction heating system and a temperature sensor. The induction heating system is configured to receive material, convert electrical energy from the main unit into thermal energy and apply the thermal energy to the material. The controller is coupled to the induction heating system and configured to receive a temperature associated with the induction heating system from the temperature sensor, and control the induction heating system to heat the material to a desired temperature.

### RELATED APPLICATIONS

The present application claims priority to U.S. provisional patent application Ser. No. 63/644,261, filed May 8, 2024, which is hereby incorporated by reference.

### FIELD OF THE INVENTION

The present disclosure relates generally to electronic vaporizers for creating a vapor from an organic material, and more particularly, to an induction based heating system that utilizes an electronic temperature sensor to provide temperature feedback to the electronic vaporizer.

### BACKGROUND OF THE INVENTION

Electronic vaporizers are devices used to vaporize an organic material, for a user to inhale the produced vapor. The vaporization of the organic substance is typically accomplished through the heating of organic compounds of a material, which is solid, or liquid based. The heating results in the phase-change of (at least a portion of) the organic compounds, from their solid or liquid state to a gas state, which can then be transferred into a user through direct inhalation. The heating can also result in the alteration of the organic compounds from one chemical species to another through the application of heat, with the new species being the compound that is to be vaporized at higher temperatures.

A desire among the design and engineering of electronic vaporizers is for a high degree of accuracy and control the device has on its outputting temperature. Ideal and accurate heating temperatures are desired to achieve the optimal vapor, that is not irritating to the user, and that preserves the vaporization of the desired organic compounds without unwanted secondary reactions. Vaporization will not occur at too low of temperatures or may result in very low-density vapor that is not ideal for the user's experience. Excessive temperatures can be irritating to the user, causing discomfort to their throat or lungs. Additionally, heating the organic compounds to too high of temperatures may result in the compounds undergoing unwanted heat-induced chemical reactions forming unwanted byproducts.

Vaporizers come in a wide range of configurations, but generally are composed of the following components: an electronic heating element which converts electrical power to thermal energy, a chamber to hold the organic substance, the electronics to control and power the heat source, and to power the system, and several optional components that have become the norm for many electronic vaporizers such as filters, airflow regulators, decorative LEDs, electronic screens, electronic charging ports, wireless charging peripherals, and other user-interface design components.

A differentiation among electronic vaporizers is the electronic heat source and the methods of controlling outputting thermal power or temperature of that heat source. The two most common types of electrical heating systems for vaporizers are resistive/joule-based heating elements, and induction heating systems. While laser, or radiative heating systems have been explored for vaporizers and some commercial products do exist, these are niche and do not show any significant improvements in functionality or design compared to resistive-heating elements and induction heating systems. The methodology of how the vaporizer's heat source transfers the generated heat to the desired organic compound varies with vaporizer design, with different devices using conduction, convection, or radiation-based heat-transfer or a combination thereof. The configuration described in this background will be that of a conduction-based system, where the heat source conductively heats the organic compound either directly, or through an intermediary material that is in physical contact with both the heat source and the organic compound.

A resistive/joule heating system utilizes the electrical resistance of an electrical conductor to an applied electrical current to create heat. This is commonly accomplished through the passage of an electrical current through a metallic filament, with the body that houses or composed of the resistive-heating commonly referred to as the “heating element”. Heating elements can be composed of free-floating filaments, or be filaments encapsulated in an electrically resistive material. These encapsulated heating elements allow for the heating element to be shaped in a geometry that is beneficial for the intended use and allows for the generated heat to be directed to an intended region. These encapsulate heating elements allow for easier manufacturing and assembly in devices, since the encapsulation prevents the filaments from being damaged or misoriented.

The most common type of encapsulated heating elements are ceramic heating elements, where the heating filament is embedded in a ceramic structure, with at least two electrical leads that protrude from the heating element that allow for an electrical connection to the embedded heating filaments. A high temperature ceramic is most commonly utilized for vaporizer heating elements due to their high strength, high temperature stability, low reactivity, good thermal conductivity, and their low-cost and ease in manufacturing. Ceramic heating elements can be manufactured in a wide range of shapes, such as plates, tubules, cups, and rods. These ceramic heating elements can include multiple heating filaments embedded within their structure. These additional filaments can be operated independently, with each having its own unique heating characteristics, or be in series as to provide the same heating to different regions of the ceramic structure. The number of electrical leads protruding from the heating element will be dependent on the number of heating filaments and their arrangement, with a minimum of two electrical leads required to complete the circuit.

Ceramic heating elements can have their produced heat be controlled by different means dependent on their structure. The simplest method of controlling the heat from a heating element is through voltage control, where the voltage applied to the heating element results in a constant heat generation rate that is tuned for specific purposes. This method of heat control is not adequate for devices that require a constant temperature output, since the heating element is designed for a controlled heat rate, with temperature dependent significantly on the operation and design of the heating system. A common method temperature control for a heating element is temperature coefficient resistance (TCR), where the heating filament's resistance is proportional to a temperature dependent on the heating filament material selection. TCR allows for adequately accurate temperature control through the use of electronics that measure the resistance between the heating elements to determine temperature and alter the applied current to the heating element to maintain the desired temperature. Inaccuracies in the TCR temperature control can arise due to manufacturing tolerances of the heating filament that can alter the relation between temperature-resistance. Another inaccuracy in TCR can arise from the compromise in selection of the heating filament material between the need for a filament material suitable for reaching certain temperatures at a certain rate and the need for accurate temperature control. This inaccuracy can be alleviated by the incorporation of a coupled temperature sensor(s) that provides an electrical signal to the device that is proportional to the temperature measured by the sensor. Type of temperature sensors can include contact-type sensor(s) such as an additional TCR that do not generate heat but are used purely for signal purposes, thermocouples, thermistors, or semiconductor-based sensors. These contact-type sensor(s) can be coupled to the heating element or be placed at key points of the vaporizer and provide an electrical feedback signal proportional to the temperature to the electronics of the vaporizer that can then utilize this data to adjust the power to the heating element in an effort to regulate the desired temperature of the system. Additionally, contactless-type sensor(s), such as fiber optic sensors, radiation thermometers, optical pyrometers, thermal imagers, and thermopile sensors, can also be used for providing temperature feedback but are rare due to their high cost in comparison to contact-type sensors.

A resistive heating vaporizer is typically configured where the heating element is a replaceable component of the device and may be coupled with the receptacle that stores the organic material to be vaporized. This combination of receptacle and heating element is commonly referred to as an atomizer. Atomizer based vaporizers will be configured so that the main body of the vaporizer houses the electronics, power supply, electrical interface for the user, charging receptacle, and the physical and electrical connections to connect the electronics to the replaceable atomizer.

The second most common type of heat generation source for a vaporizer is an induction-based system. This type of heating system utilizes an inductor that generates an alternating magnetic field; when a metallic object (workpiece) is placed within this field it generates heat based of hysteresis losses and eddy-currents. The most common type of inductor used in an induction heating system is an electrical coil that generates a magnetic field that is proportional to an applied current through the coil. An alternating magnetic field can be generated by applying an alternating (AC) current to the coil. The shape of the induced magnetic field will be dependent on the coil shape, which is designed in a manner to promote the heating of a specific workpiece geometry for the system. Additionally, to achieve optimal efficiencies, the alternating current frequency and amplitude must be tuned based off the selected workpiece geometry, material, and the inductor coil resistance and shape.

Currently, there are no induction based vaporizers that utilize temperature feedback sensors as a method of regulating power to the inductor to achieve a desired set-point temperature in the workpiece. A majority of the induction vaporizers on the market currently use a variable power-source that allows the user to manually adjust the power of the AC current being applied to the inductor and thus the thermal power generated in the workpiece, and not the final temperature. Some induction vaporizers will utilize complex modeling and algorithms to predict the temperature of the workpiece based off the applied AC current to the inductor along with the previous heating cycles run through the vaporizer.

An induction vaporizer is typically configured where the inductor is housed in the main body of the vaporizer along with the electronics, power supply, electrical interface for the user, and charging receptacle. The workpiece is most commonly either shaped to be a receptacle for the organic compound and heat it directly or be an insert that is placed within the receptacle that stores the organic compound.

Induction heating systems have several benefits over resistive-heating sources in electronic vaporizers. A resistive heating element is more fragile and prone to failure after prolonged use. Over time the filament will deteriorate, causing a change in its electrical resistance and eventual breakage. This requires the replacement of the heating elements or atomizers periodically by the user, while an induction system requires no replacement to the inductor or the workpiece. A resistive-heating element also only can heat in 2D configurations, such as heating in a plane or along the side-walls of a receptacle. This 2D heating configuration results in un-even heating of the organic compound, while an induction heating system can heat the workpiece uniformly throughout. An induction system also allows for all the electronics of the vaporizer to be behind a physical barrier from the organic compounds and vapor, while resistive heating systems typically require electrical connections to the atomizer or heating element which may allow for eventual contamination through these connections to the main unit's circuitry and interior. This physical barrier of an induction system can prevent this and result in a more reliable main unit. Additionally, induction heating is typically faster, more efficient, and results in less heat-loss than a resistive-heating element.

While these benefits of induction heating are novel, a large detriment to induction heating is the high-cost and complexity of the vaporizer's electrical circuitry due to the need for a high-frequency alternating current to generate the induction heating. Additionally, the alternating magnetic field may result in unwanted electrical noise that may interfere with outside electronics. The largest detriment though is that an induction system does not allow for the inclusion of contact type temperature sensors that would allow for temperature feedback, since any contact type temperature sensor near the workpiece and would be in the induction field, and would itself be inductively heated and thus cause false readings.

Significant research of induction heating systems, temperature control systems, and control software have been conducted for vaporizers as a means to achieve accurate temperature, which is key to providing users with a repeatable, enjoyable experience.

The present invention is aimed at solving one or more of the problems identified above.

### BRIEF SUMMARY OF THE INVENTION

In a first aspect of the present invention, a heating system for use in an electronic vaporizer having a main unit to supply electrical energy is provided. The heating system includes an induction heating system including a crucible device a temperature sensor and a controller. The crucible device is configured to receive material. The induction heating system configured to convert electrical energy from the main unit into thermal energy and apply the thermal energy to the material via the crucible device. The temperature sensor is positioned adjacent the crucible device and is configured to sense a temperature associated with the crucible device. The controller is coupled to the induction heating system and is configured to receive a temperature associated with the induction heating system from the temperature sensor and control the induction heating system to heat the material to a desired temperature.

In a second aspect of the present invention, an electronic vaporizer is provided. The electronic vaporizer includes a main unit, an inhalation unit, a heating system, a controller, and a user interface. The main unit is configured to supply electrical energy. The inhalation unit is coupled to the main unit. The heating system is coupled to the main unit and includes an induction heating system located within the main unit, a crucible device located within the main unit, and a temperature sensor. The crucible device is configured to receive material. The induction heating system is configured to convert electrical energy from the main unit into thermal energy and apply the thermal energy to the material via the crucible device to create vapor. The temperature sensor is configured to sense a temperature associated with the crucible. The controller is coupled to the induction heating system and is configured to receive a temperature associated with the induction heating system from the temperature sensor and control the induction heating system to heat the material to a desired temperature. The user interface is coupled to the controller and mounted to the main unit and is configured to allow a user to operate the electronic vaporizer.

In a third aspect of the present invention, an electronic vaporizer is provided. The electronic vaporizer includes a main unit configured to supply electrical energy, an inhalation unit coupled to the main unit, a heating system coupled to the main unit, a controller and a user interface. The heating system including an induction heating system located within the main unit, a crucible device located within the main unit, a temperatures sensor, and an airflow regulator. The crucible device including includes a workpiece. The main unit, the inhalation unit, and the heating system defining a main an airflow path configured to allow ambient air to enter the main unit and the crucible device and to allow the vapor to exit the crucible device and enter the inhalation unit. The main unit further includes an opening forming an inlet of the airflow path. The insert is configured to receive material. The induction heating system is configured to convert electrical energy from the main unit into thermal energy and apply the thermal energy to the material via the crucible device to create vapor. The temperature sensor is configured to sense a temperature associated with the crucible device. The airflow regulator is located within the opening and includes a body and a removable lid. The body is configured to direct incoming airflow into different regions of the insert.

In a fourth aspect of the present invention, an electronic induction heating system for use in an electronic vaporizer, the electronic vaporizer includes a main unit that houses the induction heating system, and a replaceable crucible (also known as an “insert”), where the crucible is the component in contact with the organic material to be vaporized, but also in physical contact with the workpiece and acts as an inert intermediary. The main unit is configured to supply electrical energy. The induction heating system is composed of a multi-turn solenoid coil and a metallic workpiece that is shaped as a cup-like receptacle. This induction heating system is built into the main unit and is configured to receive the insert, convert electrical energy from the main unit into thermal energy and apply the thermal energy to the insert. The induction heating system is coupled to non-contact type temperature sensor that is housed or connected to the main unit. This temperature sensor is configured to: measure the temperature associated with the workpiece or insert, and provide that measurement to the main electronics of the main unit which will control the induction heating system to heat the workpiece or insert to a desired temperature.

In fifth aspect of the present invention, the induction heating system's workpiece is removable from the main unit, and acts as the receptacle for the loading and vaporization of organic material. In another aspect of the present invention, the induction heating system is removable from the main unit of the device, allowing the user to replace the inductor coil to different configurations, such as but not limited to a pancake coil, channel coil, or internal coil. In this configuration the workpiece may be coupled to the removable induction system or be removable itself. In any of these configurations, an insert may or may not be included to act as an inert intermediary between the workpiece and the organic material.

In a sixth more aspect of the present invention, an electronic vaporizer having a main unit, a heating system and a controller is provided. The main unit is configured to supply electrical energy. The heating system is coupled to the main unit and includes an induction heating system and a temperature sensor. The induction heating system is configured to receive material, convert electrical energy from the main unit into thermal energy and apply the thermal energy to the material. The controller is coupled to the induction heating system and configured to receive a temperature associated with the induction heating system from the temperature sensor, and, control the induction heating system to heat the material to a desired temperature.

In a seventh aspect of the present invention, a heating system for use in an electronic vaporizer is provided. The electronic vaporizer includes a main unit to supply electrical energy and a controller. The heating system includes an induction heating system configured to receive material, convert electrical energy from the main unit into thermal energy and apply the thermal energy to the material. The controller is coupled to the induction heating system and is configured to receive a temperature associated with the induction heating system from the temperature sensor, and control the induction heating system to heat the material to a desired temperature.

In an eighth aspect of the present invention, an electronic vaporizer including a main unit, an inhalation unit, a heating system, a controller, a user interface and an airflow regulator is provided. The main unit is configured to supply electrical energy. The inhalation unit is coupled to the main unit. The heating system is coupled to the main unit and includes a crucible device. The controller is coupled to the heating system and configured to control the heating system to heat the material. The user interface is coupled to the controller and mounted to the main unit and configured to allow a user to operate the electronic vaporizer. The main unit, the inhalation unit, and the heating system define an airflow path configured to allow ambient air to enter the main unit and the crucible device and to allow the vapor to exit the crucible device and enter the inhalation unit. The main unit includes an opening forming an inlet of the airflow path. The airflow regulator located within the opening, the airflow regulator including a carb cap body and a removable lid, the carb cap body including an airflow channel forming part of the airflow path and configured to allow vapor to exit the crucible device, the carb cap body configured to direct incoming airflow into different regions of the crucible device when the removable lid has been removed.

In a ninth aspect of the present invention, an electronic vaporizer including a main unit, an inhalation unit, a heating system, a controller, a user interface, and an airflow regulator is provided. The main unit is configured to supply electrical energy. The inhalation unit is coupled to the main unit. The heating system is coupled to the main unit and includes a crucible device. The crucible device is positioned within the main unit. The crucible device is configured to receive material. The heating system is configured to convert electrical energy from the main unit into thermal energy and apply the thermal energy to the material via the crucible device to create vapor. The controller is coupled to the heating system and is configured to control the induction heating system to heat the material. The user interface is coupled to the controller and is mounted to the main unit. The user interface is configured to allow a user to operate the electronic vaporizer. The main unit, the inhalation unit, and the heating system define an airflow path configured to allow ambient air to enter the main unit and the crucible device and to allow the vapor to exit the crucible device and enter the inhalation unit. The airflow regulator is located within the opening and includes a carb cap body and a removable lid. The carb cap body includes an airflow channel forming part of the airflow path and is configured to allow vapor to exit the crucible device. The carb cap body is configured to direct incoming airflow into different regions of the crucible device when the removable lid has been removed.

In a tenth aspect of the present invention, an electronic vaporizer including a main unit, an inhalation unit, a heating system, a controller, a user interface, and an airflow regulator. The main unit is configured to supply electrical energy. The inhalation unit is coupled to the main unit. The heating system is coupled to the main unit and includes a crucible device, an insert, and a temperature sensor. The crucible device includes a workpiece. The main unit, the inhalation unit, and the heating system define an airflow path configured to allow ambient air to enter the main unit and the crucible device and to allow the vapor to exit the crucible device and enter the inhalation unit. The main body further includes an opening forming an inlet of the airflow path. The insert is positioned adjacent the workpiece and is configured to receive material.

The heating system is configured to convert electrical energy from the main unit into thermal energy and apply the thermal energy to the material via the crucible device to create vapor, the temperature sensor configured to sense a temperature associated with the crucible. The controller is coupled to the heating system and is configured to receive a temperature associated with the heating system from the temperature sensor, and to control the heating system to heat the material to a desired temperature. The user interface is coupled to the controller and is mounted to the main unit. The user interface is configured to allow a user to operate the electronic vaporizer. The main unit, the inhalation unit, and the heating system define an airflow path configured to allow ambient air to enter the main unit and the crucible device and to allow the vapor to exit the crucible device and enter the inhalation unit. The main unit includes an opening forming an inlet of the airflow path. The airflow regulator is located within the opening. The airflow regulator includes a carb cap body and a removable lid. The carb cap body includes an airflow channel forming part of the airflow path and is configured to allow vapor to exit the crucible device The carb cap body is configured to direct incoming airflow into different regions of the crucible device when the removable lid has been removed.

In an eleventh aspect of the present invention, a heating system for use in an electronic vaporizer having a main unit to supply electrical energy and a controller is provided. The heating system includes a crucible device, and a controller. The crucible device is positioned within, and fixedly coupled to, the heating system and is configured to receive material. The heating system is configured to convert electrical energy from the main unit into thermal energy and apply the thermal energy to the material via the crucible device. The controller is configured to control the heating system to heat the material.

In a twelfth aspect of the present invention, an electronic vaporizer including a main unit, an inhalation unit, a heating system, a crucible device, a controller, and a user interface is provided. The main unit is configured to supply electrical energy. The inhalation unit is coupled to the main unit. The heating system is coupled to the main unit and includes a crucible device. The crucible device is positioned within, and fixedly coupled to the main unit. The crucible device is configured to receive material. The heating system is configured to convert electrical energy from the main unit into thermal energy and apply the thermal energy to the material via the crucible device to create vapor. The controller is coupled to the heating system and is configured to control the heating system to heat the material. The user interface is coupled to the controller, is mounted to the main unit and configured to allow a user to operate the electronic vaporizer

In a thirteen aspect of the present invention, an electronic vaporizer including a main unit, an inhalation unit, a heating system, and a user interface is provided. The main unit is configured to supply electrical energy. The inhalation unit is coupled to the main unit. The heating system is coupled to the main unit and includes a crucible device, an insert, a temperature sensor, an airflow regulator and a controller. The crucible device includes a workpiece. The main unit, the inhalation unit, and the heating system define an airflow path configured to allow ambient air to enter the main unit and the crucible device and to allow the vapor to exit the crucible device and enter the inhalation unit. The main unit further includes an opening forming an inlet of the airflow path. The insert is insert positioned adjacent the workpiece. The insert is configured to receive material. The heating system is configured to convert electrical energy from the main unit into thermal energy and apply the thermal energy to the material via the crucible device to create vapor. The temperature sensor is configured to sense a temperature associated with the crucible. The air flow regulator is located within the opening. The air flow regulator includes a carb cap body and a removable lid. The carb cap body is configured to direct incoming airflow into different regions of the insert. The controller is coupled to the heating system and is configured to receive a temperature associated with the heating system from the temperature sensor and to control the induction heating system to heat the material to a desired temperature. The user interface is coupled to the controller and mounted to the main unit and configured to allow a user to operate the electronic vaporizer.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1A is a perspective view of an electronic vaporizer, according to an embodiment of the present invention.

FIG. 1B is a functional block diagram of the electronic vaporizer of FIG. 1A, according to an embodiment of the present invention.

FIG. 1C is a functional block diagram of a controller of the electronic vaporizer of FIG. 1A.

FIG. 2A is a first side view of the electronic vaporizer of FIG. 1A.

FIG. 2B is a front perspective view of the electronic vaporizer of FIG. 1A.

FIG. 2C is a second side view of the electronic vaporizer of FIG. 1A.

FIG. 2D is rear view of the electronic vaporizer of FIG. 1A.

FIG. 3A is an exploded view of the electronic vaporizer of FIG. 1A.

FIG. 3B is a first internal view of the electronic vaporizer of FIG. 1A.

FIG. 3C is a second internal view of the electronic vaporizer of FIG. 1A.

FIG. 3D is a cross section of an airflow regulator of the electronic vaporizer of FIG. 1A, according to a first embodiment.

FIG. 3E is a perspective view of the airflow regulator of FIG. 3D.

FIG. 3F is a second cross section of the airflow regulator of FIG. 3D.

FIG. 3G is a perspective view of a grommet of the airflow regulator of FIG. 3D.

FIG. 3H is a cross section of the grommet of FIG. 3G.

FIG. 4 is a first partial cross-sectional view of the electronic vaporizer of FIG. 1A.

FIG. 5 is a control diagram associated with the electronic vaporizer of FIG. 1A, according to an embodiment of the present invention.

FIG. 6 is a second partial cross-sectional view of the electronic vaporizer of FIG. 1A.

FIG. 7A is a first perspective view of a manifold of the electronic vaporizer of FIG. 1A.

FIG. 7B is a second perspective view of the manifold of FIG. 7A.

### DETAILED DESCRIPTION OF THE INVENTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” “an example”, or “aspect” means that a particular feature, structure or characteristic described in connection with the embodiment of example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Referring to the FIGS, and in operation, wherein like numerals indicate like or corresponding parts throughout the several views, the present invention an provides electronic vaporizer 10 that is configured to aerosol an organic material and to provide the resultant vapor to a user to inhale. The organic material may include, but is not limited to, organic liquids and/or wax-like materials that are derived naturally or artificially made.

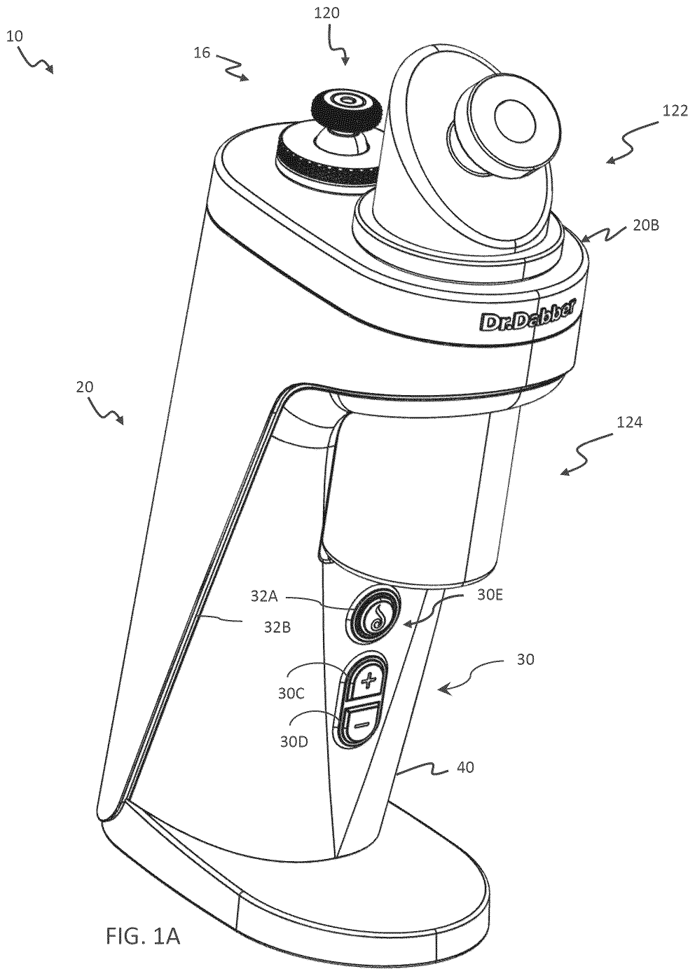

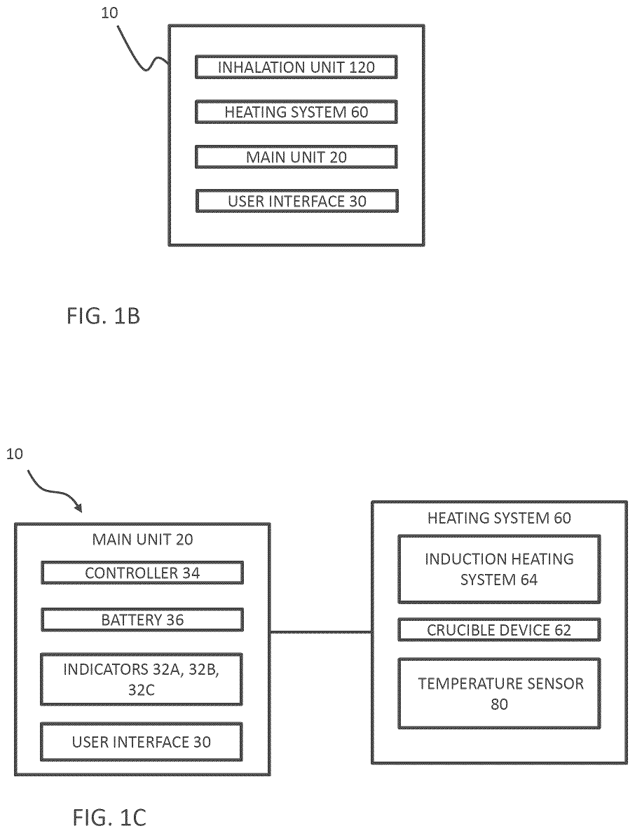

With reference to FIGS. 1A-1C, 2A-2D, 3A-3H and 4-6, in one embodiment of the present invention, an electronic vaporizer 10 is provided. In the illustrated embodiment, the electronic vaporizer 10 includes a main unit 20, an inhalation unit 120, a heating system 60, a controller 34, and a user interface 30.

The main unit 20 is configured to supply electrical energy. The inhalation unit 120 is coupled to the main unit 20. The heating system 60 is coupled to the main unit 20 and may include an induction heating system 64 located within the main unit 20, a crucible device 62 located within the main unit 20, and a temperature sensor 80. The crucible device 62 is configured to receive material, such as a liquid-based or solid organic substance.

The induction heating system 64 is coupled to, and maybe located with, the main unit 20 and is configured to convert electrical energy from the main unit 20 into thermal energy and apply the thermal energy to the material via the crucible device 62 to create vapor. The temperature sensor 80 is configured to sense a temperature associated with the crucible device 62. The controller 64 is coupled to the induction heating system 64 and is configured to receive a temperature associated with the induction heating system 64 from the temperature sensor 80 and control the induction heating system 64 to heat the material to a desired temperature. The user interface 30 is coupled to the controller 34 and mounted to the main unit 20 and is configured to allow a user to operate the electronic vaporizer 10.

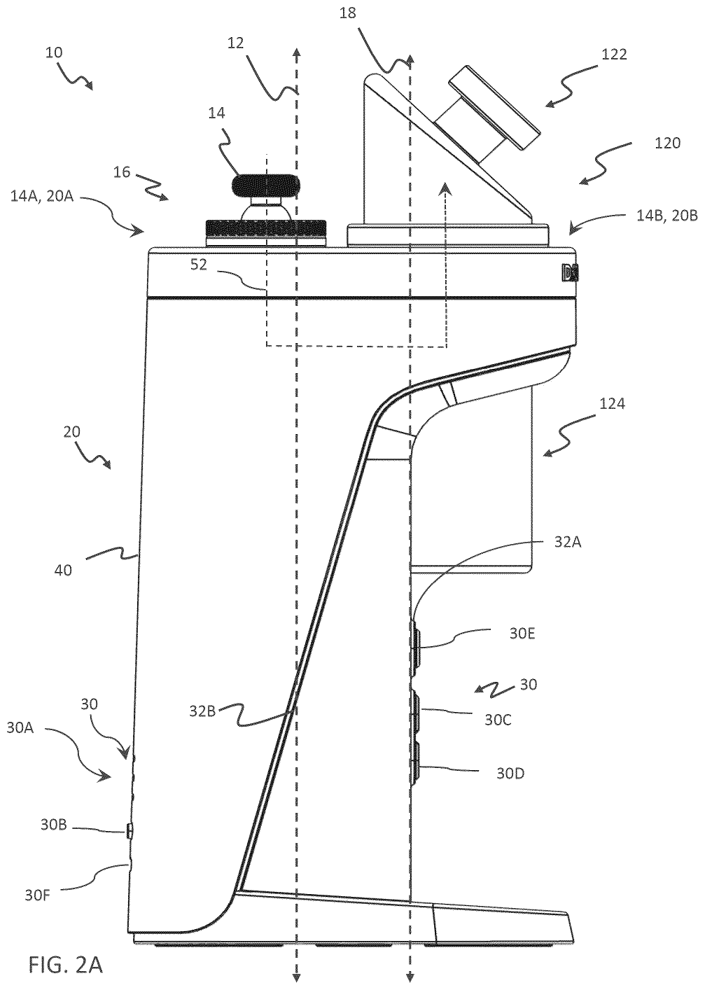

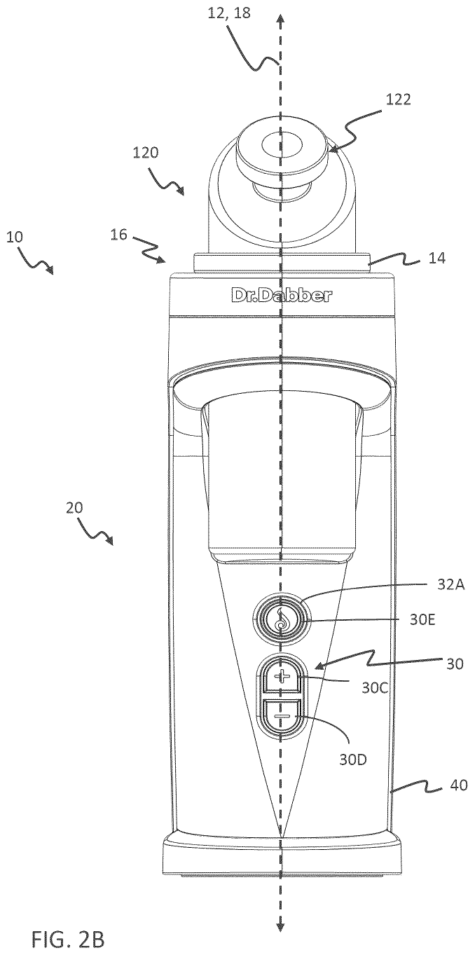

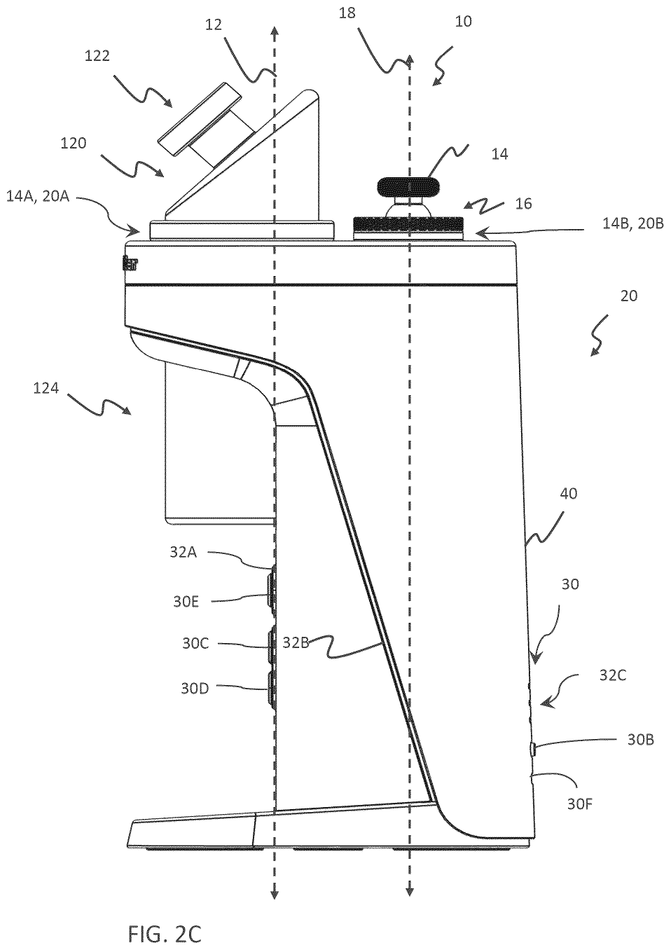

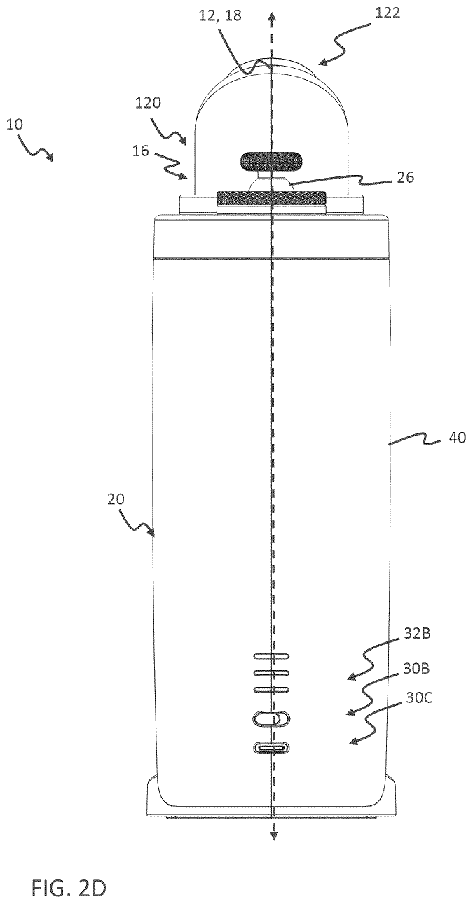

In one embodiment the electronic vaporizer 10 includes a main unit 20, a heating system 60, an airflow regulator 16, and an inhalation unit 120. The inhalation unit 120 includes a mouthpiece 122. In the illustrated embodiment, the electronic vaporizer 10 has a central axis 12 (see FIG. 2A) In the illustrated embodiment, the main unit 20 and the induction heating system 60 are aligned and generally centered (along with many of the components thereof) on the central axis 12. The mouthpiece 122 may be centered along a second axis 18 (see FIG. 2A).

As discussed in further detail below, the crucible device 62 may include a workpiece 68 and insert 72. In one embodiment the workpiece 68 is cup shaped in the shape of a crucible 72 and configured to receive the material. In the illustrated embodiment, the workpiece 68 may be a cup-shaped crucible 70 configured to receive a removable insert 72 to receive the material, The airflow regulator 16 may include a body 24 and a removable lid, which may also be referred to as a carb cap, 26 The carb cap 26 may include an optional connector to maintain the carb cap 26 in place while allowing removal. For example, the connector may be magnetic (see below). In one embodiment, the crucible device 62 may be removable or may be fixedly installed within the main unit 20. In other embodiments, one or both of the workpiece 68 (or crucible 70) and/or the insert 72 may be fixedly installed or removable.

In one embodiment of the present invention, the material may be placed directly in the cup-shaped crucible 70. In another embodiment of the present invention, the material may be placed in the removable insert 72 which may be removed and/or replaced.

As shown in FIGS. 1C, 4, and 6, the crucible device 62 configured to receive material. The induction heating system 64 is configured to convert electrical energy from the main unit 20 into thermal energy and apply the thermal energy to the material via the crucible device 62 to create vapor. The temperature sensor 80 may be positioned below the crucible device 62 configured to sense a temperature associated with the crucible device 62. The controller 34 is coupled to the induction heating system 64. In one embodiment, the controller 34 is configured to receive a temperature associated with the induction heating system 64 from the temperature sensor 80 and to control the induction heating system 64 to heat the material to a desired temperature.

The user interface 30 is coupled to the controller 34 and mounted to the main unit 20 and configured to allow a user to operate the electronic vaporizer 20.

In one embodiment, the induction heating system 64 includes a multiturn inductor coil 66. The crucible device 62 may be positioned within the multiturn inductor coil 66, i.e., the coil encloses or surrounds the workpiece 68. Alternatively, the induction heating system 64 may include a pancake coil, a channel coil, a multiturn coil, or a combination therefore.

Generally, the main unit 20, the inhalation unit 120, and the heating system 60 define an airflow path 52 (see below) configured to allow ambient air to enter the main unit 20 and the crucible device 62 and to allow the vapor to exit the crucible device 62 and enter the inhalation unit 120.

With specific reference to FIGS. 1B-1C, functional block diagrams of an electronic vaporizer 10 according to an embodiment of the present invention is shown. As discussed above, the electronic vaporizer 10 may include the main unit 20, a heating system 60, and the inhalation unit 120. As discussed in more detail below, the heating system 60 may include an induction heating system 64.

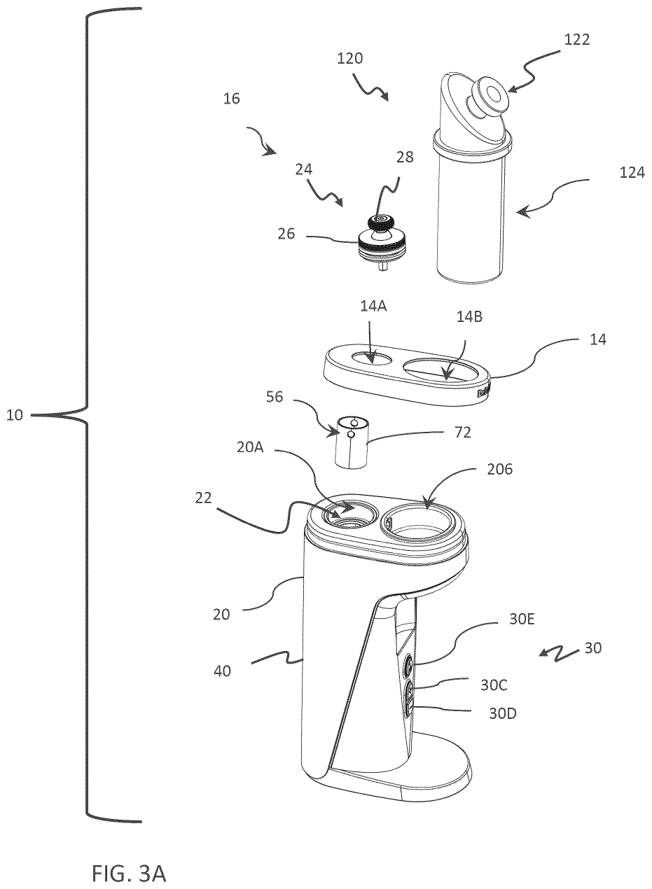

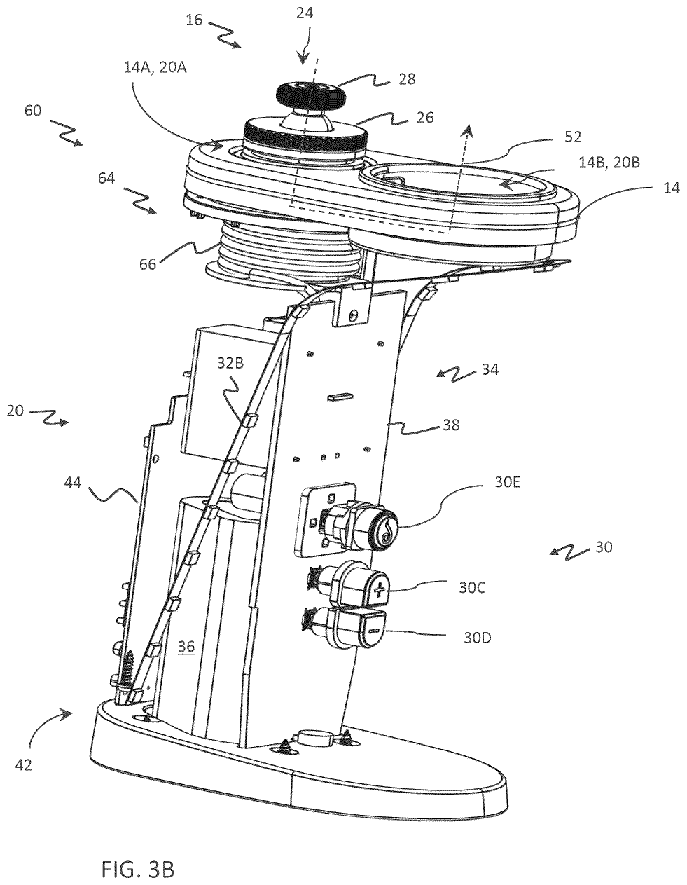

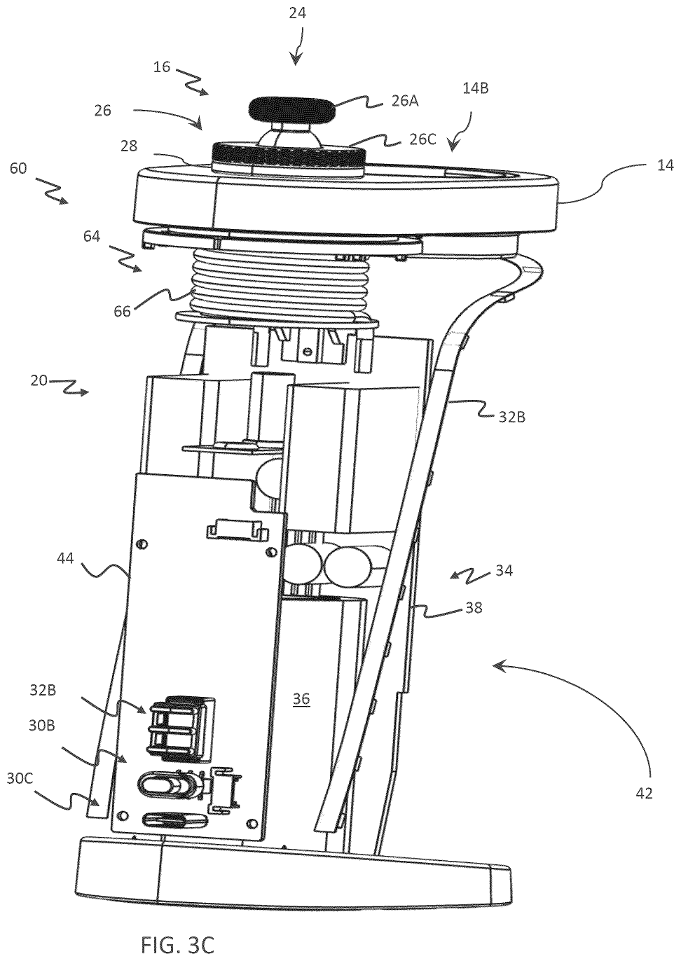

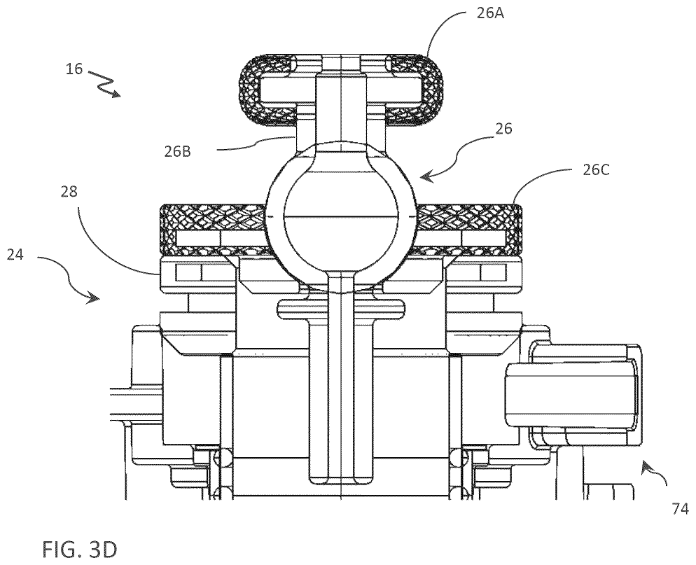

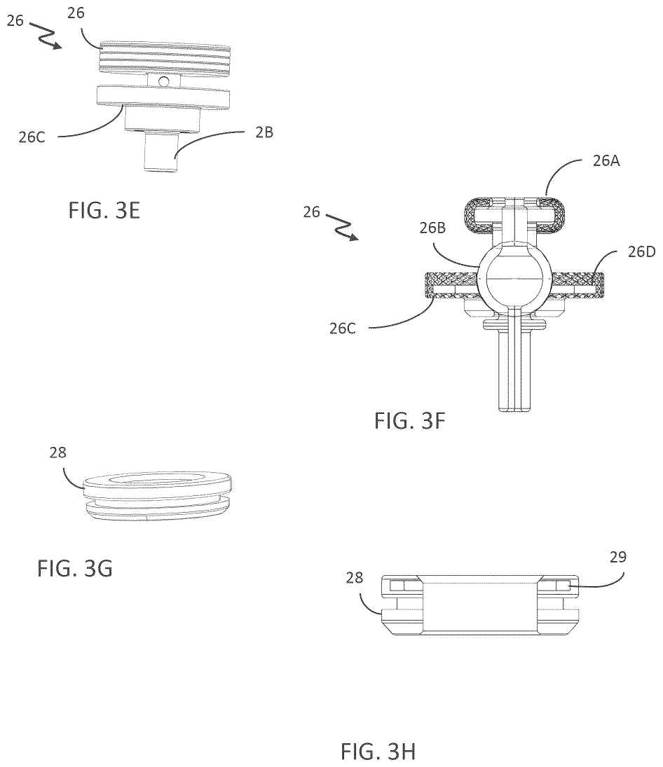

The main unit 20 may include the one or more indicators 32A, 32B, 32C (see FIGS. 2A-2D and 3A-3C) to provide information and/or feedback to the user. In the illustrated embodiment, a set of three indicators 30A are provided on a rear surface of the main unit 20 (see FIGS. 2D, 3C) that are configured to provide an indication of the battery life. Also, on the rear surface of the main unit 20, an on/off switch 30B and a USB-C charge/data port 30C may be provided. The USB-C charge/data port 30C allows for fast charging of the device 10. Settings of the electronic vaporizer 10 may be customized through the USB-C charge/data port 30C and/or through a wireless connection. In the illustrated embodiment, a single LED ring 32A is used to indicate different functionality of the device, which may be coupled to a string of LED lights 32B. This LED ring 32A and string of LED lights 32B may be used to indicate that the device is heating, has reached the desired temperature, or that the device has connected to an external device through a wireless connection. The string of LED lights 32B may provide additional (aesthetic) illumination.

With reference to FIGS. 1A, 2A-2C, and 3B, a user input interface 30 may be provided on a front surface of the main unit 20. In the illustrated embodiment, the user input interface 30 includes a go button 30A and set of plus and minus buttons 30C, 30D. Actuation of the go button 30A can initiate the heating process and actuation of the plus and minus buttons 30C, 30D change the temperature settings of the device. Actuation of combinations of the buttons 30A, 30C, 30D may provide different functions.

As shown, the electronic vaporizer 10 includes a controller 34 and a battery 36 which in the illustrated embodiment are stored or located within the main unit 20. The battery 36 may be a lithium-ion cell, a capacitor or other suitable energy storage device. In other embodiments of the invention, the battery can be circumvented by a connection to an external power supply. The user input interface 32 allows the user to operate the electronic vaporizer 10. In general, the user can control the electronic vaporizer by utilizing the user input interface 32 to adjust the settings. Alternatively, or in addition, the settings of the electronic vaporizer may be adjusted remotely through a wired or wireless connection, using a user device, such as cell phone or computer.

In one aspect of the present invention, the device 10 includes an induction heating system 64 to heat the organic material. As shown in FIGS. 3B, 3C, 5, 7 and 8, the induction heating system 64 may include a solenoid inductor coil 66 (see below) and a metallic workpiece 68. In one embodiment, the temperature sensor 80 is a thermopile or infrared sensor 82 (contactless temperature sensor). In other embodiments, the temperature sensor 80 may be in contact with the workpiece 68.

In one aspect of the present invention, the mouthpiece 120 is removable and positioned, at least partially, within the main unit 20. With specific reference to FIG. 1A. 2A. 2C and 3A, the main unit 20 includes a mouthpiece aperture 46 for receiving the mouthpiece 122.

In an alternative embodiment, the mouthpiece 122 may be coupled to the vaporizer 10 via a quick connect adapter (not shown) and the main unit 20, the heating system 60, the mouthpiece 120, and the quick connect adapter may aligned about the second axis 18. One such electronic vaporizer is disclosed in U.S. Pat. No. 11,1064,738, issued on Jul. 20, 2021, which is hereby incorporated by reference.

An exemplary mouthpiece 122 is shown in the FIGS. In general, the mouthpiece 122 allows the user to inhale creating low pressure within the mouthpiece 122 and to transfer the low pressure to the heating system 60 via the inhalation unit 120. In the illustrated embodiment, the inhalation unit 122 is a percolating type of mouthpiece and is made from glass. However, it should be noted that that the illustrated mouthpiece is illustrative only. Any type of mouthpiece, including a non-percolating mouthpiece, or permanently affixed mouthpieces, may be used without departing from the spirit of the invention.

The main unit 20 includes the control electronics and user interface/controls necessary to operate the electronic vaporizer 10 and to provide power to the induction heating system 64 (see below). The induction heating system 64 may house the crucible device 62. In one embodiment, the crucible device 62 may include a workpiece 68, which may be cup-shaped and an insert 72 in which the organic material is inserted or loaded. Generally, the insert 72 is typically made of a non-reactive material such as a quartz glass, sapphire, other inorganic glasses or crystals, or high temperature ceramic to preserve the flavor of the produced vapor. Further, such materials resist corrosion and do not chemically react with the material loaded therein.

As discussed in more detail below, an induction heating system 64 converts electrical energy into thermal energy and applies the thermal energy to the material (see below). In the illustrated embodiment, the insert 72 may be in the form of a cup for holding the material.

The inhalation unit 120 collects exhausted vapor from the insert 72 and delivers the vapor to the user through the user's inhalation on the mouthpiece 122. In the illustrated embodiment, the main unit 20 is a hand-held device that controls the electronic functions of the electronic vaporizer 10. The main unit 20 further acts as the hub that locks in the insert 72 and the inhalation unit 122.

As will discussed in further detail below, the main unit 20 may include a well 22 (see FIG. 3A) that is configured to house the heating workpiece 66, which also houses the insert 72. The heating workpiece 66 may or may not be removable from the well 22. The well 22 may be formed by cup-shaped workpiece 66. In one embodiment the heating workpiece 66 is made from titanium, but can be made from any material that can be inductively heated.

The main unit 20 may include a first aperture 20A and a second aperture 14B. The first aperture 20A forms an air inlet for allowing ambient air to enter the heating system 60. The first aperture 20A is configured to receive the removable lid 26. As will be explained in further detail below, the first (or air inlet) aperture 20A, when the removable lid 26 is removed, allows air to enter the main unit 20 and the heating system 60. In the illustrated embodiment, the second aperture 20B is configured to receive the mouthpiece 122.

With specific reference to FIG. 3A, in the illustrated embodiment the insert 22 is removable from the main unit 20. The electronic vaporizer 10 or heating system 60 may include a removable top cover 14. As discussed below, the removable top cover 14 creates the airflow pathway (when removed or open) and/or acts as a hub to direct airflow. As shown, the removable top cover 14 includes a first aperture 14A (corresponding to the first aperture 20A of the main unit 20) and a second aperture 14B (corresponding to the second aperture 20B of the main unit 20). The mouthpiece 120 may be inserted into the main unit 20 through the second aperture 14B, 20B. With the mouthpiece 120 removed, the removable top cover 14 may also be removed. With the removable top cover 14 removed, the insert 72 may be removed for cleaning and/or replacement. In the illustrated embodiment, the removable lid 26 is removably coupled to the top cover 14 and and/or the body 24 of the airflow regulator 16 and, thus, may be removed from the main unit 20.

The removable lid 26 may be provided to cover the top of the electronic vaporizer 10 and protect the insert 72 and internal components of the electronic vaporizer 10. The removable lid 26 may be connected to the main unit 20 by a silicone seal (not shown) with a living hinge to allow the removable lid 26 to be removed but remain connected to the electronic vaporizer 10 to prevent the removable lid 26 from being lost.

The main unit 20 houses the primary electronics of the device. In the illustrated embodiment, the main unit 20 includes a controller 34 (see below) that controls the functionality of the electronic vaporizer 10 (see below). The main unit 20 further includes a power cell battery 36 that provides power to the electronic vaporizer 10 and a push-button tactile switch 28 that, in the illustrated embodiment, provides the only physical interface between the electronic vaporizer 10 and the user. Additional interface between the electronic vaporizer 10 and the user can exist through external peripheral devices that are wireless coupled to the electronic vaporizer 10. These external peripheral devices can include a tablet, smart phone, or personal computer.

The main unit 20 includes an outer housing 40. With specific reference to FIG. 1C, the main unit 20 includes a chassis 42. The battery 36 may be removably mounted to the chassis 42. A printed circuit board (PCB) 38 including the controller 34 may also be mounted to the chassis 42. As shown, the user interface 32 may be mounted to the PCB 38. The indicators 32A, 32B, 32C, on/off switch 30B, and the USB-C port 30F may be mounted to a second PCB 44.

Heat is applied to the insert 72 via the induction heating system 64. The main unit 20 houses the induction heating system 46. The induction system 64 includes the crucible device 62, which may include the workpiece 68 (which may be in the form of a heating crucible 70 which is configured to receive the insert 72). Generally, the induction system 64 wirelessly heats the workpiece 68 to produce vapor for inhalation.

The temperature sensor 80 may be located within the main unit 20 to sense a temperature associated with the heating crucible 66. In the illustrated embodiment, the temperature sensor 80 is positioned adjacent and beneath the heating crucible 66. In one embodiment the temperature sensor 80 is an infrared (IR) sensor (thermopile sensor) 82. In other embodiments of the invention, there may be a viewport cut (not shown) into the heating crucible 66, to allow the temperature sensor 80 to directly measure the temperature of the insert 72. In other embodiments of the invention, the temperature sensor 80 may be configured to measure the heating crucible's 66 sidewall instead of the base. In other embodiments of the invention, multiple temperature sensors 80 may be used to measure different locations of the heating crucible 66 or insert 72.

Generally, the controller 34 (under the control of a user through the user input interface 30) provides alternating current to the induction coil 66 resulting in an alternating magnetic field. The workpiece 68 or the crucible 70 and the insert 72 are positioned within the induction coil 66. The alternating magnetic field is inductively coupled to the workpiece 68 which generates heat therein by the resistance of the workpiece 68 to the induced eddy currents.

The heat generated in the workpiece 68 is conductively transferred to the insert 72 and to the material (to be vaporized) contained within the insert 72. Separation of the heating crucible 66 from the material to be vaporized by the insert 72 promotes a cleaner vaporization of the material. The insert 72 is removable for cleaning and or replacement. Since the temperature sensor 80 is separated from the insert 72 by the heating crucible 66, the temperature sensor 80 is not directly measuring the temperature of the insert 72. The logic within the controller 34 may include an experimentally derived time-delay module to approximate the temperature of the insert 72 based on the sensed temperature of the workpiece 68.

In other embodiments, the crucible 70 and the insert 72 may be combined into a single integrated removable component.

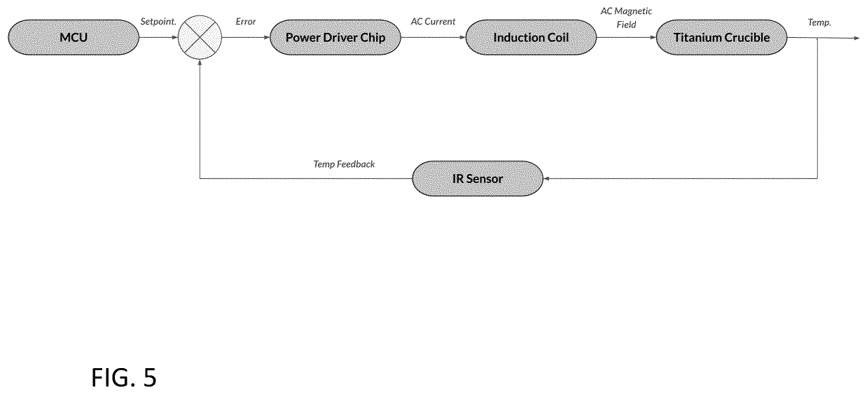

In the illustrated embodiment, the temperature sensor 80 continuously detects or senses the temperature of the base or bottom of the workpiece 68. The temperature is provided to the controller 34. The controller 34 implements logic (see FIG. 5) utilizing temperature feedback to accurately control the temperature of the workpiece 68 by regulating the power and/or frequency of the alternating current provided to the induction coil 66.

With particular reference to FIGS. 3D-3H, the removable lid 26 of the airflow regulator may include a top 26A, a rod 26B, and a cover 26C. The top 26A and/or the cover 26C may have ridges to assist with gripping. In the illustrated embodiment, the removable lid 26 is removably attached to the main unit 20 by magnets (see below). In the illustrated embodiment, the body 24 of the airflow regulator 16 includes a grommet 28 located within the first aperture 20A of the main unit 20 and/or the first aperture 14A of the removable top cover 14. In the illustrated embodiment, a ring magnet 26D is embedded within the cover 26C of the removable lid 26. A ring-shaped attractor 29 composed from metal, such as steel or nickel, is embedded within the grommet 28. It should be noted, that location of the ring magnet 26D and the attractor 29 may be reversed. In other words, the ring magnet 26D may be located within the grommet 28 and the attractor 29 may be located with the top 26C of the removable lid 26.

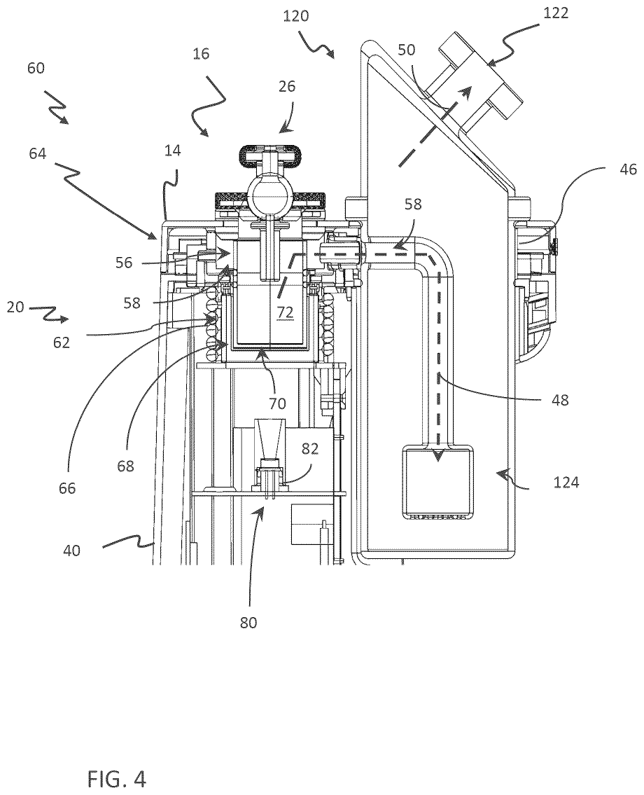

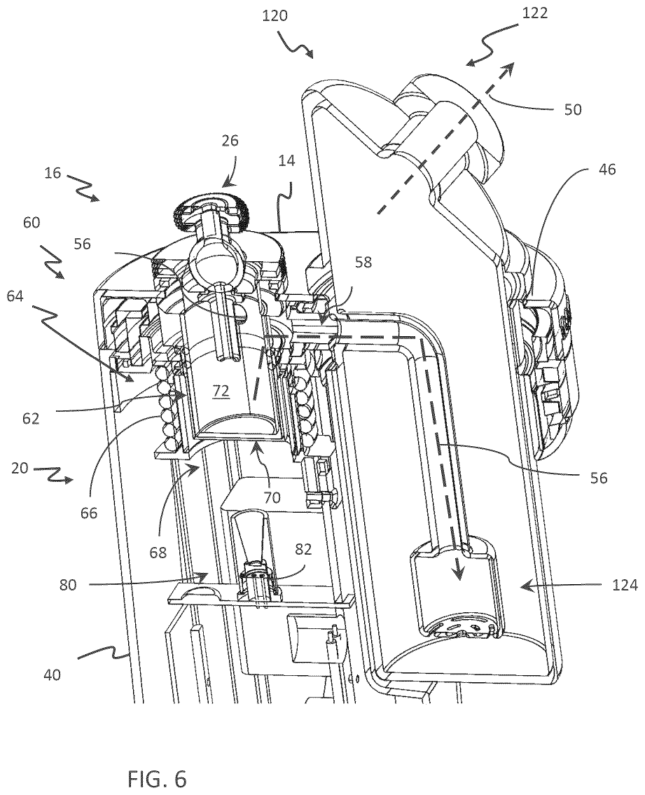

With reference to FIGS. 4, and 6 operation of the electronic vaporizer 10 may be discussed in terms of air/vapor flow within the electronic vaporizer 10. The pressure used to drive fresh air into the vaporizer 10 and to drive vapor out of the vaporizer 10, is provided by the negative pressure created through inhalation through the mouthpiece 122.

Vapor is produced via the heating of the organic material within the insert 72 to the organic material's vaporization temperature. The body 24 of the airflow regulator 16 directs incoming airflow to different regions of the insert 72 to agitate and spread the material (or oil) to be vaporized to improve vapor production. The air stream from the body 24 of the airflow regulator 16 also promotes vapor production by reducing the localized air pressure in the insert 72.

In the illustrated embodiment, the insert 72 includes a number of openings 56 (FIG. 3A), for example two or four openings 56. located adjacent or near the top of the insert 72. Vapor (see dashed arrow 48, FIG. 4)) from the vaporization of the material exits the insert 72 through the openings 56 and travels through pathways (see dashed arrow) 58 defined, at least partially, by or within the removable top cover 14 and/or the main unit 20. As shown, the insert 72 extends above the heating crucible 70 such that openings 56 are open to the pathways 58, i.e., are uncovered by the heating crucible 70.

The vapor indicated by arrow 48 continues from the pathways 56 into interior pathway of the inhalation unit (or glass attachment) 120 to a percolator 124 formed within the inhalation unit 120. The inhalation unit 120, which may be partially filled with water, has a number of slits that create a high amount of percolation from vapor traveling therethrough. The water cools the vapor and acts as a filter. Cooled, filtered vapor (arrow 50) exits that inhalation unit 120 and is inhaled by the user through the mouthpiece 122.

### Airflow Path

In some embodiments of the present invention, the electronic vaporizer 10 defines an airflow path 52 (see FIGS. 2A, 3B) configured to allow ambient air to enter the main unit 20 and the crucible device 62. As discuss in more detail below, the electronic vaporizer 10 may include an airflow regulator 16. In the illustrated embodiment, the airflow regulator 16 includes a carb cap body 24. In the illustrated embodiment, the carb cap body 24 includes an airflow channel 54 (FIG. 3D) forming part of the airflow path 52. The airflow channel 54 and the airflow path 52 are configured to allow vapor to exit the crucible device 62. The carb cap body 24 is configured to direct incoming airflow into different regions of the crucible device 62 when the removable lid 26 has been removed.

In the illustrated embodiment, the electronic vaporizer 10 includes the main unit 20, the inhalation unit 120, the heating system 60, the controller 34, the user interface 30 and the airflow regulator 16. The main unit 20 is configured to supply electrical energy. The inhalation unit 120 is coupled to the main unit 20. The heating system 60 is coupled to the main unit 20 and includes the crucible device 62. The controller 34 is coupled to the heating system 60 and is configured to control the heating system 60 to heat the material. The heating system 60 may be in induction heating system 64 (as described above) or other type of heating system, such as a resistive based heating system. The user interface 30 is coupled to the controller 34 and mounted to the main unit 20 and configured to allow a user to operate the electronic vaporizer 10. The main unit 20, the inhalation unit 120, and the heating system 60 define an airflow path 52 configured to allow ambient air to enter the main unit 20 and the crucible device 62 and to allow the vapor to exit the crucible device 62 and enter the inhalation unit 120. The main unit 20 includes an opening 20 forming an inlet of the airflow path 52. The airflow regulator 16 is located within the opening 20. The airflow regulator 16 includes the carb cap body 24 and a removable lid 26. The carb cap body 24 includes the airflow channel 54 that forms part of the airflow path 52, The airflow channel 54 is configured to allow vapor to exit the crucible device 62. The carb cap body 24 is configured to direct incoming airflow into different regions of the crucible device 24 when the removable lid 26 has been removed.

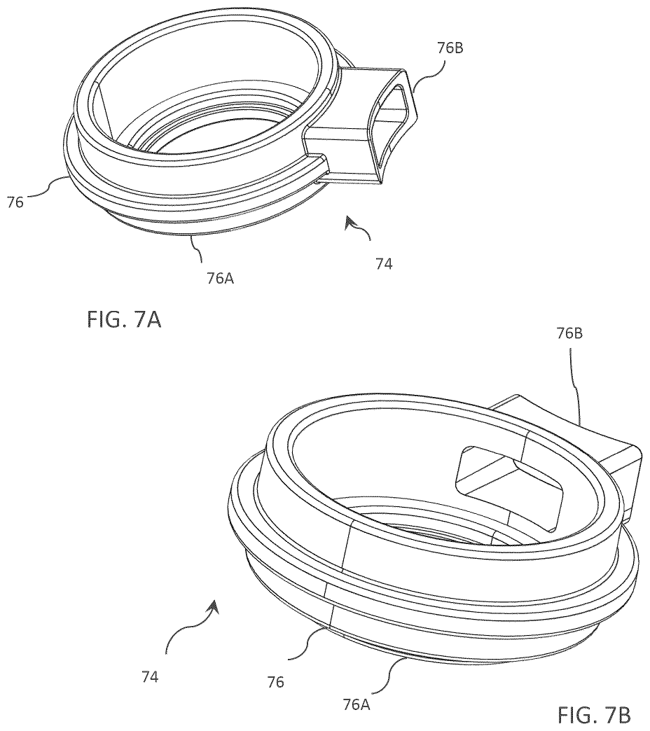

With specific reference to FIGS. 3D, 7A, and 7B, in the illustrated embodiment, the electronic vaporizer 10 may include a manifold 74 within the main unit 20. As shown, the manifold 74 includes a manifold body 76. The manifold body 76 includes a central aperture 76A and an exhaust port 76B. The central aperture 76A and the exhaust port 76B form part of the airflow path 52.

### Fixed Crucible Device

In some embodiments of the present invention, the electronic vaporizer 10 includes a heating system 60 with a non-removable crucible device 62. The electronic vaporizer 10 includes a main unit 20 to supply electrical energy and a controller 34. The heating system 60 includes the crucible device 62, the temperature sensor 80, and the controller 34. The crucible device 62 is positioned within, and fixedly coupled to, the heating system 60 and is configured to receive material. The heating system 60 is configured to convert electrical energy from the main unit 20 into thermal energy and apply the thermal energy to the material via the crucible device 62. The temperature sensor 80 is positioned adjacent the crucible device 62 and is configured to sense a temperature 80 associated with the crucible device 62. The controller 34 is configured to receive a temperature associated with the heating system 60 from the temperature sensor 80 and to control the heating system 60 to heat the material to a desired temperature.

### INDUSTRIAL APPLICABILITY

With reference to the drawings, and in operation, the present invention provides an electronic vaporizer 10 that includes a main unit 20, an airflow regulator 16, an insert 72, and an inhalation unit 120 with a mouthpiece 122.

The main unit 20 houses all electronics, the user interface, and controls the power delivered to the induction heating system 64. The induction heating system 60 includes the heating crucible 66 and the insert 72 where material is loaded into, which converts electrical energy into thermal energy. The inhalation unit 120 acts as the coupling between the mouthpiece 122 and the main unit 20 and controls airflow into the insert 72. The mouthpiece 122 collects the exhausted vapor produced from the insert 72 and delivers the vapor to the user as the user inhales.

The main unit 20, in the illustrated embodiment, is a hand-held device that controls the electronic functions of the electronic vaporizer 20 and acts as the hub that locks in the insert 72, along with the inhalation unit 120. The main unit 20 includes a well 22 that receives the insert 72.

The main unit 20 houses the primary electronics of the electronic vaporizer 10. In the illustrated embodiment, the main unit 20 may include one or more printed circuit (PC) boards 38, 44 that control the functionality of the electronic vaporizer 10, control or mount the indicators 30A, the on/off switch 30B, the USB-C port 30C, and the user interface 32.

In one aspect of the present invention, the heating crucible 66 is composed from titanium and the temperature sensor 80 is an infrared (IR) sensor 82. The temperature feedback of the titanium heating crucible 66 from the IR temperature sensor 80 to the device's controller allows the correct power regulation to the induction coil 68 so that the organic material is heated to the desired temperature.

The induction heating system 64 may heat the heating crucible 66 to indirectly heat the material to be vaporized (within the insert 72) or may be used to directly heat the material directly. In the illustrated embodiment, the temperature sensor 80 senses the temperature of the heating crucible 66 from which the temperature of the material may be derived using a data model.

The electronic vaporizer 10 may (or may not include): a removable inhalation unit 120 or mouthpiece 122. The electronic vaporizer 10 may include a built-in battery pack that may/may not be replaceable, and/or may be powered by an external power supply. The electronic vaporizer may include a permanently fixed or replaceable metallic heating crucible 66 for induction heating.

The induction coil 68 may be cylindrical, pancake, or a combination thereof, or any other suitable shape. The induction coil 68 may composed of solid, hollow, or braided metallic wiring (or combination thereof).

The electronic vaporizer 10 may be controlled by the user directly inputting into controls electronic vaporizer 10, or be remotely operated by the user, using a remote, a Bluetooth connected APP, or other wireless forms of connection.

The insert 72 may be composed of an intermediary material that is used to vaporize organic compounds can be composed of metallic, ceramic, or glasses or composite materials that are able to withstand the high temperatures needed for vaporization of the organic compounds. Such materials include: borosilicate glass, quartz glass, fused silica, SiC, AlN, Al2O3 ceramic, Sapphire Crystal, Silicon Crystal, etc. . . .

In a first alternative embodiment, the heating crucible 62 may be replaceable. The IR temperature sensor 80 may be protected behind a quartz lens that allows for the IR signal to pass through to the IR temperature sensor 80.

In a second alternative embodiment, the heating crucible 66 may include a hole or aperture in a surface that allows for the temperature sensor 80 to measure the temperature of the insert 72.

In a third alternative embodiment, the induction heating system 64 may include a braided induction coil.

In a fourth alternative embodiment, the induction system 64 may include a pancake or flat induction coil (flat coil) position adjacent the bottom of the heating crucible 66 to heat the bottom of the heating crucible 66. An IR or contact style temperature sensor 82 may be provided to measure the sidewall of the heating crucible 66.

In another aspect of the present invention, the electronic vaporizer 10 may include a replaceable heating crucible 66, along with a replaceable insert 72.

In another aspect of the present invention, the electronic vaporizer may include a permanently affixed heating crucible 66 and no insert 72. In this embodiment of the invention the heating crucible directly heats the to be vaporized organic material and outgasses it to the user through the mouthpiece 122. The vaporization chamber in the heating system 60 and the separate chamber 126 which may be located within the inhalation unit 120 may be connected through an internal air pathing in the electronic vaporizer 10. Both chambers may be accessed for cleaning or access via an optional removable top cover 14.

Additionally, an airflow regulator may be included that controls how airflow is directed into the vaporization chamber. The airflow regulator may be provided within the carb cap 24. Alternatively, the airflow regulator may be provided within the replacement top cover 14.

The removable top cover is optional and may be replaced with a top of the device having openings for each of the two chambers. The outgassing chamber 126 may include a glass water filtration device with a mouthpiece for the goal of cooling or filtering out the vapor.

Alternatively, the outgassing chamber 126 may be as simple as a mouthpiece directing the vapor to the user during inhalation.

Although specific features of various embodiments of the disclosure may be shown in some drawings and not in others, this is for convenience only. In accordance with the principles of the disclosure, any feature of a drawing or other embodiment may be referenced and/or claimed in combination with any feature of any other drawing or embodiment.

This written description uses examples to describe embodiments of the disclosure and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A heating system for use in an electronic vaporizer having a main unit to supply electrical energy and a controller, comprising:
an induction heating system including a crucible device;
a temperature sensor, the crucible device configured to receive material, the induction heating system configured to convert electrical energy from the main unit into thermal energy and apply the thermal energy to the material via the crucible device, the temperature sensor positioned adjacent the crucible device; and,
a controller coupled to the induction heating system, the controller configured to:
receive a temperature associated with the crucible device from the temperature sensor, and,
control the induction heating system to heat the material to a desired temperature.

2. The heating system, as set forth in claim 1, wherein the temperature sensor is an infrared sensor.

3. The heating system, as set forth in claim 1, wherein the crucible device includes a workpiece, the heating system further including an insert associated with the workpiece.

4. The heating system, as set forth in claim 3, wherein the workpiece and the insert are cup-shaped, the insert being removable from the workpiece.

5. The heating system, as set forth in claim 4, wherein the induction heating system includes a multiturn inductor coil.

6. The heating system, as set forth in claim 3, wherein the temperature received by the controller is associated with the insert.

7. The heating system, as set forth in claim 1, wherein the temperature sensor is spaced from the crucible.

8. The heading system, as set forth in claim 1, wherein the temperature sensor in contact with the crucible device.

9. The heating system, as set forth in claim 1, wherein the induction heating system includes an inductor coil, wherein the inductor coil is one of a pancake coil, a channel coil, or a multiturn coil.

10. An electronic vaporizer, comprising:
a main unit configured to supply electrical energy;
an inhalation unit coupled to the main unit;
a heating system coupled to the main unit and including:
an induction heating system having a crucible device, and
a temperature sensor, the crucible device configured to receive material, the induction heating system configured to convert electrical energy from the main unit into thermal energy and apply the thermal energy to the material via the crucible device to create vapor, the temperature sensor configured to sense a temperature associated with the crucible; and,
a controller coupled to the induction heating system, the controller configured to:
receive a temperature associated with the induction heating system from the temperature sensor, and,
control the induction heating system to heat the material to a desired temperature; and,
a user interface coupled to the controller and mounted to the main unit and configured to allow a user to operate the electronic vaporizer.

11. The electronic vaporizer, as set forth in claim 10, wherein the temperature sensor is an infrared sensor.

12. The electronic vaporizer, as set forth in claim 10, wherein the crucible device includes a workpiece, the electronic vaporizer further including an insert associated with a workpiece.

13. The electronic vaporizer, as set forth in claim 12, wherein the workpiece and the insert are cup-shaped, the insert being removable from the workpiece.

14. The electronic vaporizer, as set forth in claim 12, wherein the induction heating system includes an inductor coil, wherein the inductor coil is one of a a pancake coil, a channel coil, or a multiturn coil.

15. The electronic vaporizer, as set forth in claim 12, wherein the main unit, the inhalation unit, and the heating system defining a main an airflow path configured to allow ambient air to enter the main unit and the crucible device and to allow the vapor to exit the crucible device and enter the inhalation unit.

16. The electronic vaporizer, as set forth in claim 12, wherein the temperature received by the controller is associated with the insert.

17. The electronic vaporizer, as set forth in claim 16, wherein the crucible device includes one or more apertures forming part of the airflow path.

18. The electronic vaporizer, as set forth in claim 16, wherein the main unit includes an opening forming an inlet of the airflow path, further including an airflow regulator located within the opening, the airflow regulator including a carb cap body and a removable lid, the carb cap body configured to direct incoming airflow into different regions of the insert.

19. The electronic vaporizer, as set forth in claim 18, the carb cap body including an airflow channel forming part of the airflow path and configured to allow vapor to exit the crucible device.

20. An electronic vaporizer, comprising:
a main unit configured to supply electrical energy;
an inhalation unit coupled to the main unit;
a heating system coupled to the main unit and including:
an induction heating system having a crucible device, the crucible device including a workpiece, the main unit, the inhalation unit, and the heating system defining an airflow path configured to allow ambient air to enter the main unit and the crucible device and to allow the vapor to exit the crucible device and enter the inhalation unit, the main unit further including an opening forming an inlet of the airflow path,
an insert positioned adjacent the workpiece;
a temperature sensor, the insert configured to receive material, the induction heating system configured to convert electrical energy from the main unit into thermal energy and apply the thermal energy to the material via the crucible device to create vapor, the temperature sensor configured to sense a temperature associated with the crucible,
an airflow regulator located within the opening, the airflow regulator including carb cap body and a removable lid, the carb cap body configured to direct incoming airflow into different regions of the insert;
a controller coupled to the induction heating system, the controller configured to:
receive a temperature associated with the induction heating system from the temperature sensor, and,
control the induction heating system to heat the material to a desired temperature; and,
a user interface coupled to the controller and mounted to the main unit and configured to allow a user to operate the electronic vaporizer.

21. The electronic vaporizer, as set forth in claim 18, wherein the temperature sensor is an infrared sensor.

22. The electronic vaporizer, as set forth in claim 18, wherein the workpiece and the insert are cup-shaped, the insert being removable from the workpiece.

23. The electronic vaporizer, as set forth in claim 22, wherein the temperature received by the controller is associated with the insert.

24. The electronic vaporizer, as set forth in claim 22, wherein the induction heating system includes an inductor coil, wherein the inductor coil is one of a a pancake coil, a channel coil, or a multiturn coil.

25. The electronic vaporizer, as set forth in claim 24, wherein the crucible device includes one or more apertures forming part of the airflow path.

26. The electronic vaporizer, as set forth in claim 24, the carb cap body including an airflow channel forming part of the airflow path and configured to allow vapor to exit the crucible device.
